(19) United States
(12) Patent Application Publication
(10) Pub. No.: US 2021/0163364 A1
(43) Pub. Date: Jun. 3, 2021

(54) 3D PRINTING MATERIAL, PREPARATION METHOD AND USE THEREOF

(71) Applicant: KUNSHAN KADAM NEW MATERIAL TECH CO., LTD., Kunshan, Jiangsu (CN)

(72) Inventors: CHUNSHU HOU, Jiangsu (CN); LONGJIN ZHOU, Jiangsu (CN); WENJIE HOU, Jiangsu (CN)

(21) Appl. No.: 17/047,999

(22) PCT Filed: Jul. 9, 2018
(86) PCT No.: PCT/CN2018/095004

§ 371 Date: Oct. 15, 2020

(30) Foreign Application Priority Data
Apr. 18, 2018 (CN) 201810348633.X

(51) Int. Cl. C04B 35/587; C04B 35/488; C04B 35/119; C04B 35/52; C04B 35/565; C04B 35/634; C04B 35/638; C04B 35/64; C04B 35/626; B28B 1/00; B33Y 10/00; B33Y 40/20; B33Y 70/10

(52) U.S. Cl. CPC C04B 35/587; C04B 2235/606; C04B 35/119; C04B 35/522; C04B 35/565; C04B 35/63476; C04B 35/63488; C04B 35/638; C04B 35/64; C04B 35/62695; C04B 35/62655; B28B 1/001; B33Y 10/00; B33Y 40/20; B33Y 70/10; C04B 2235/3244; C04B 2235/3217; C04B 2235/425; C04B 2235/3873; C04B 2235/3826; C04B 2235/5436; C04B 2235/5427; C04B 2235/6026; C04B 2235/6567; C04B 35/4885

(57) ABSTRACT

Disclosed are a 3D printing material, a preparation method and use thereof. The 3D printing material is linear, and it comprises, in percent by volume, 16 to 82% of a non-metal material, 17.9 to 83% of a first binder and 0.1 to 1% of a second binder. The material is obtained by pre-treating the non-metallic material, then mixing with the first binder, and extruding.

### TECHNICAL FIELD OF THE INVENTION

The present application relates to the field of 3D printing, specifically relates to a 3D printing material, a preparation method and use thereof.

### BACKGROUND OF THE INVENTION

3D printing technology, also known as three-dimensional printing technology, is a technology for constructing objects by taking digital model documents as the basis, utilizing adhesive materials such as powder-like or plastic material, and printing in a layer by layer manner. Without any machining or any die, it can produce parts of any shape from computer graphic data, thus greatly shortening the development period of a product, increasing productivity and reducing production cost. Products such as lampshades, body organs, jeweleries, football boots customized according to the foot shape of a footballer, racing car parts, solid-state batteries and personally customized cellphones, and violins, all can be manufactured by using this technology.

The 3D printing is actually a general designation of a series of rapid prototyping technologies, the basic principle thereof is laminated manufacturing, which forms the cross-sectional shape of a workpiece in the X-Y plane by scanning form of a rapid prototyping machine, discontinuously performs displacement of a layer thickness in the Z coordinate, and finally forms a three-dimensional workpiece. At present, the rapid prototyping technology is divided into 3DP technology, SLA (full name Service-Level Agreement) technology, SLS (full name Selective Laser-Sintering) technology, DMLS (full name Direct Metal Laser-Sintering) technology, FDM (full name Fused Deposition Modeling) technology, and the like.

The 3D printing technology was first applied to plastic materials. FDM Fused Deposition Modeling technology is the main method at present, and is to heat and melt a hot melting material, and under the control of a computer, selectively coat the material on a working table according section profile information by a three-dimensional nozzle, and rapid cool down, to form a layer of section. After the modeling of one layer is completed, the machine working table is lowered by a height (that is, the layer thickness) to continue modeling, until the entire solid shape is formed. It has a variety of modeling materials, molded parts with high precision and low cost, and mainly suitable for molding small plastic parts. However, the plastic products produced in this way have low strength and cannot meet the requirements of the customer. In order to enhance the strength of the products and improve the performance of the products, DMLS technology adopts alloyed powder materials as raw materials, and utilizes the energy laser formed after metal focusing to melt the raw materials and perform 3D printing lamination. It has the characteristics of high precision, high strength, fast speed, and smooth surfaces of finished product, and is generally applied in aeronautical and industrial accessory manufacturing industries, and can be used for high performance mold design, and the like. However, laser sintering apparatuses are complex and the preparation process has high energy consumption, and taking factors such as product resolution, equipment cost, product appearance requirements and mass production capacity into overall consideration, it is still unable to be widely popularized and used and not suitable for high melting-point non-metal materials. Therefore, the current 3D printing method for non-metal materials generally uses SLA (full name Service-Level Agreement) technology to meet the current industrial needs, and this process needs to go through forming, degreasing and sintering processes. Moreover, due to the use of slurries, the sintering shrinkage rate of the products is too large, and the thermal deformation is also large.

CN106270510A discloses a method for manufacturing a metal/alloy part through printing of a plastic 3D printer, and the method comprises the steps of pretreatment for sintering of a raw material, cladding of the raw material, powder reduction, 3D printing, degreasing, sintering and the like. CN106426916A discloses a 3D printing method comprising: mixing a powdery material to be processed and a powdery nylon material with one another; melting the nylon material using selective laser sintering technologies to adhere the material to be processed so as to form a raw blank; heating the raw blank and thermally degreasing the raw blank to volatile the nylon material; heating the raw blank to the sintering temperature of the material to be processed so as to sinter the raw blank; cooling the environmental temperature for the raw blank to the room temperature so as to obtain a dense part. The above two methods although combine the powder injection molding and the 3D printing technologies, both methods use powdery or granulate materials in feeding modes, and mainly have the following defects: when using powdery or granulate materials to perform 3D printing, the raw materials are needed to be layer-by-layer spread out and coated in the whole region from bottom to top, which greatly increases feed amount and causes a waste of the materials. In the melting process, due to the overlarge thermal zone, the material is easy to melt and cross-link, and when using laser heating to melt and combine, due to high molecular materials have low melt points, it is easily cause the surrounding materials to be heated and melted, which will affect the accuracy and appearance of the products thereof. Meanwhile, the powdery or granulated feeds have irregular shapes, and thus cannot be effectively and evenly coating, which easily causes thickness unevenness on the product surface.

CN104669407A discloses a ceramic printing method which adds ceramic powder into each layer of paraffin, and this method is easy to cause delamination and product joint strength problems. Later, the slurry ceramic powder method was put forward, and then evolved to a light-cured slurry method. To maintain the high fluidity of the light-cured slurry to spread out on the working surface rapidly and stably, the solid content of ceramic powder thereof is low, which results in that the sintering shrinkage rate of the back-end process is too large, and the products are easily deformed.

CN105728729A discloses a metal/ceramic powder molding method comprising the following steps: mixing a thermoplastic bonding agent and a metal powder or ceramic powder, and extrusion molding a printing material for a fused deposition type 3D printer. However, the powder solid content of the printing material obtained by this molding method cannot be increased, and can only reach 14% to 15%, and the high-temperature sintering shrinkage rate of the products printed using this printing material is up to 47% to 48%, while the high-temperature sintering shrinkage rate for normal CIM is 20% to 30%, and as the increase of bonding agent, the products are easily deformed during the high-temperature sintering, which is bad for mass production.

CN106984805A discloses a feed for 3D printing as well as a preparation method thereof and an application thereof, and the feed is metal powder packaged by a high-molecular binder, and is linear. After being printed into a raw blank with a preset shape through a 3D printer, the linear feed is sequentially degreased and sintered, so that a metal product with a complex structure and high precision can be obtained. However, this preparation method cannot be used for non-metal materials, because the size distribution D90 of metal powder is 20 to 25 μm (referring to that particles with particle sizes less than 20 to 25 μm account for 90 wt % of the total material), and the size distribution D90 of non-metal powder is 0.5 to 1.0 μm (3D printing materials obtained from non-metal powders with large particle sizes will result in sintering compactness problems, low density, and reduced mechanical properties), the overall surface area of the non-metal powder per unit weight is much larger than that of the metal powder, and the fluidity of the non-metal material is much lower than that of the metal material under the same high-molecular binder content. Under such circumstances, the non-metal materials cannot be prepared into high-solid content linear material for 3D printing. As a result, it is the direction of practitioners' efforts to enable non-metal materials to use this process technology to achieve the same effect as metal materials.

### SUMMARY OF THE INVENTION

The following is a summary of the subject described in detail herein. This summary is not intended to limit the protection scope of appended claims.

The present application aims at providing a 3D printing material, a preparation method and use thereof. A solid content of non-metal materials in the 3D printing material is significantly increased, the obtained 3D printed products have small high-temperature sintering shrinkage and less variation, and an increased product yield; meanwhile, problems such as raw material waste, complex and expensive equipment, and low accuracy caused by the solid form of the feed when the existing powder injection forming technology and photosensitive resins for the 3D printing technology are combined are avoided, and it has a simple preparation method, and can be widely used for 3D printing.

Unless otherwise specified in this application, vol % refers to volume percentage, and wt % refers to mass percentage.

To achieve the above purpose, the present application employs the following technical solution:

The first purpose of the present application is to provide a 3D printing material, the 3D printing material is linear, and in percent by volume, it comprises the following components:

a non-metallic material 16 to 82%;

a first binder 17.9 to 83%; and

a second binder 0.1 to 1%.

The volume percentage of the non-metallic material in the 3D printing material is 16 to 82%, for example, 16%, 20%, 25%, 30%, 35%, 40%, 45%, 50%, 55%, 60%, 65%, 70%, 75%, 82%, or the like; the volume percentage of the first binder is 17.9 to 83%, for example, 17.9%, 30%, 35%, 40%, 45%, 50%, 55%, 60%, 65%, 70%, 75%, 80%, 82%, or the like; the volume percentage of the second binder is 0.1 to 1%, for example, 0.2%, 0.3%, 0.5%, 0.8%, 0.9%, or the like.

It is well known to those skilled in the art that the sum of the volume percentages of the components used in the 3D printing material should be 100%.

The solid content of the non-metal material in the 3D printing material is significantly increased, the obtained 3D printed products have small high-temperature sintering shrinkage and less variation, and an increased product yield; meanwhile, problems such as raw material waste, complex and expensive equipment, and low accuracy caused by the solid form of the feed when the existing powder injection forming technology and photosensitive resins for the 3D printing technology are combined are avoided.

It is well known to those skilled in the art that the first binder and the second binder can be removed during the degreasing and high-temperature sintering processes after the preparation of the printed part.

When the 3D printing material of the embodiment of the present disclosure is applied to 3D printing, it can feed according to the feed amount required by each layer of the printed part, saving raw materials; meanwhile, the accuracy of the product surfaces can be controlled by selecting different line diameters and controlling the heating temperature; and, the 3D printing material can be melted by heating using an ordinary thermocouple, without any need for an expensive photocuring printer equipment.

The diameter of the 3D printing material is 0.1 to 5 mm, for example, 0.1 mm, 0.5 mm, 1 mm, 1.5 mm, 2 mm, 2.5 mm, 3 mm, 3.5 mm, 4 mm, 4.5 mm, 5 mm, or the like, preferably 1 to 3 mm, more preferably 1.75 mm.

The size distribution D90 of the non-metal material is 0.5 to 1.0 μm (referring to that particles with particle sizes less than 0.5 to 1.0 μm account for 90 wt % of the total material), for example, 0.6 μm, 0.7 μm, 0.8 μm, 0.9 μm, or the like. The smaller the powder particle diameter, the larger the surface area per unit weight, and the higher the polymer content to obtain the same fluidity, the larger the oversizing factor (OSF); at the same time, during the mixing-milling process, the powder friction heat causes the cracking of the polymer to produce a pungent and biting taste, therefore, the use of the second binder can maintain the sintering characteristics of the fine powder and obtain low OSF and high fluidity.

Preferably, the non-metal material is selected from any one or a combination of at least two of oxide ceramic materials, carbide ceramic materials, nitride ceramic materials, and graphite materials, and the typical but non-limiting combinations are, for example, oxide ceramic materials and carbide ceramic materials, oxide ceramic materials and nitride ceramic materials, carbide ceramic materials and graphite materials.

The oxide ceramic materials are selected from any one or a combination of at least two of alumina ceramics, zirconia ceramics, and piezoelectric ceramics, and the typical but non-limiting combinations are, for example, alumina ceramics and zirconia ceramics, alumina ceramics and zirconia ceramics and piezoelectric ceramics.

The carbide ceramic materials are preferably selected from any one or a combination of at least two of silicon carbide ceramics, tungsten carbide ceramics, vanadium carbide ceramics, titanium carbide ceramics, tantalum carbide ceramics, and boron carbide ceramics, and the typical but non-limiting combinations are, for example, silicon carbide ceramics and tungsten carbide ceramics, vanadium carbide ceramics and titanium carbide ceramics and tantalum carbide ceramics, boron carbide ceramics, silicon carbide ceramics and tungsten carbide ceramics and vanadium carbide ceramics.

The nitride ceramic materials are selected from any one or a combination of at least two of aluminum nitride ceramics, silicon nitride ceramics, boron nitride ceramics, titanium nitride ceramics, and chromium nitride ceramics, and the typical but non-limiting combinations are, for example, aluminum nitride ceramics and silicon nitride ceramics, boron nitride ceramics and titanium nitride ceramics and chromium nitride ceramics.

The piezoelectric ceramics are for example lead zirconate titanate (PZT) ceramic series, or strontium bismuth titanate (SBT) ceramic series.

Preferably, the first binder is selected from the plastic-based binders and/or wax-based binders.

The main filler of the plastic-based binders is preferably polyoxymethylene (POM), and the main filler of the wax-based adhesive is preferably paraffin (PW).

Preferably, the second binder is selected from thermosetting polymer materials and/or thermoplastic polymer materials, preferably thermosetting polymer materials.

Preferably, the thermosetting polymer materials are selected from any one or a combination of at least two of phenolic resin, urea-formaldehyde resin, melamine resin, unsaturated polyester resin, epoxy resin, organic silicone resin, and polyurethane. The typical but non-limiting combinations are, for example, phenolic resin and urea-formaldehyde resin and melamine resin, unsaturated polyester resin and epoxy resin, and organic silicone resin and polyurethane. The main design point is that during the subsequent internal mixing process after agglomerating, the thermosetting polymer will not be crushed, this crushing will result in insufficient binder and reduce fluidity.

Preferably, the thermoplastic polymer materials are selected from any one or a combination of at least two of polypropylene, polyvinyl chloride, polystyrene, polyoxymethylene, polycarbonate, polyamide, acrylic plastic, polysulfone, and polyphenylene oxide. The typical but non-limiting combinations are, for example, polypropylene and polyvinyl chloride, polystyrene and polyoxymethylene and polycarbonate, polyamide and acrylic plastic, and polysulfone and polyphenylene oxide. The thermoplastic polymer materials may also be other polyolefins and their copolymers.

The second purpose of the present application is to provide a preparation method of the 3D printing material described above, and the preparation method comprises the following steps:

(1) mixing a formulated amount of the non-metallic material with a formulated amount of the second binder and then granulating to obtain pellets;

(2) mixing the pellets with a formulated amount of the first binder, to obtain a mixture; and

(3) extruding the mixture, to obtain the 3D printing material.

The size distribution D90 of the non-metal material in Step (1) is 0.5 to 1.0 μm (referring to that particles with particle sizes less than 0.5 to 1.0 μm account for 90 wt % of the total material), for example, 0.6 μm, 0.7 μm, 0.8 μm, 0.9 μm, or the like.

The size distribution D90 of the pellets obtained in Step (1) is 30 to 100 μm (referring to that particles with particle sizes less than 30 to 100 μm account for 90 wt % of the total material), for example, 40 μm, 45 μm, 50 μm, 55 μm, 62 μm, 67 μm, 69 μm, 70 μm, 75 μm, 80 μm, 90 μm, 95 μm, or the like, and preferably is 30 to 50 μm.

Preferably, the granulating in Step (1) is spray drying granulation which can quickly, safely, and effectively obtain the desired particle size distributed powder.

Preferably, the mixing in Step (2) comprises mixing-milling.

Preferably, the chamber temperature in the mixing mill during the mixing-milling is 165 to 220° C., preferably 175 to 200° C., for example, 170° C., 175° C., 180° C., 185° C., 190° C., 195° C., 210° C., or the like, and further preferably is 185° C.

Preferably, the mixing-milling time is 0.5 to 2 h, for example, 0.6 h, 0.8 h, 1 h, 1.2 h, 1.5 h, 1.8 h, 2 h, or the like, and preferably is 1 h.

As a preferred technical solution, the preparation method of the 3D printing material comprises the following steps:

(1) mixing a formulated amount of the non-metallic material with a size distribution D90 of 0.5 to 1.0 μm with a formulated amount of the second binder and then performing spray drying granulation to obtain pellets with a size distribution D90 of 30 to 100 μm;

(2) mixing-milling the pellets with a formulated amount of the first binder, with a chamber temperature of 165 to 220° C. and a mixing-milling time of 0.5 to 2 h during mixing-milling, to obtain a mixture;

(3) extruding the mixture, to obtain the 3D printing material.

In the preparation method of the 3D printing materials provided by the embodiments of the present disclosure, firstly the ultrafine non-metallic powder with D90 of 0.5 to 1.0 μm is preprocessed, that is, the non-metallic powder is immersed in a solvent containing a thermosetting polymer, then spray dried at 120 to 140° C. to form semi-solidified powder agglomerates, so that the powder can be formed into a larger mass and its overall surface area is greatly reduced, and then it is mixed evenly with the first binder and extruded to obtain a high-solid content linear 3D printing material. Through being preprocessed by the solvent containing the second binder, the high-solid content and high-toughness linear 3D printing material can be obtained at the same content of the first binder.

The third purpose of the present application is to provide a 3D printing method, the 3D printing method uses the 3D printing material described above.

As a preferred technical solution, the 3D printing method comprises the following steps:

(1) taking the 3D printing material as a raw material to print a raw blank with a preset shape through a 3D printer;

(2) degreasing the raw blank to obtain a brown blank; and

(3) sintering the brown blank to obtain a molded part.

The degreasing in Step (2) causes over 80% of the total binders (the total amount of the first binder and the second binder) can separated from the product, and if the degreased amount is high, for example 82 wt %, 85 wt %, 88 wt %, 89 wt %, 90 wt %, 92 wt %, 95 wt %, or the like, the cracking defects in the subsequent sintering process will be greatly reduced.

Preferably, the degreasing in Step (2) is selected from any one or a combination of at least two of thermal degreasing, water degreasing, catalytic degreasing, and solvent degreasing, and the typical but non-limiting combinations are, for example, thermal degreasing and water degreasing, catalytic degreasing and solvent degreasing, thermal degreasing and water degreasing and catalytic degreasing.

Preferably, the catalyst of the catalytic degreasing is nitric acid and/or oxalic acid.

Preferably, the sintering temperature in Step (3) is 1200 to 1500° C., for example, 1210° C., 1220° C., 1230° C., 1240° C., 1250° C., 1300° C., 1350° C., 1400° C., 1450° C., 1480° C., or the like, and further preferably is 1300-1450° C.

Preferably, the sintering time in Step (3) is 2 to 3 h, for example, 2 h, 2.1 h, 2.2 h, 2.3 h, 2.4 h, 2.5 h, 2.6 h, 2.7 h, 2.8 h, 2.9 h, 3 h, or the like.

Preferably, post-processing is performed after sintering in Step (3), those skilled in the art can perform post-processing on the sintered part according to actual conditions, and can independently select the post-processing method.

As a preferred technical solution, the 3D printing method comprises the following steps:

(1) taking the 3D printing material as a raw material to print a raw blank with a preset shape through a 3D printer;

(2) degreasing the raw blank, and removing over 80 wt % of the total binders, to obtain a brown blank; and

(3) sintering the brown blank at a sintering temperature of 1200 to 1500° C. and a time of 2 to 3 h to obtain a sintered part, and post processing the sintered part to obtain a molded part.

The 3D printing method provided by the embodiment of the present disclosure combines the powder injection molding technology with the 3D printing technology to obtain a -non-metal and high solid content linear 3D printing material, and when applied to the 3D printing, it can feed according to the feed amount required by each layer of the printed part, saving raw materials; meanwhile, the accuracy of the product surfaces can be controlled by selecting different line diameters and controlling the heating temperature; and, the 3D printing material can be melted by heating using an ordinary thermocouple, without any need for an expensive photocuring printer equipment.

The fourth purpose of the present application is to provide a method for increasing the non-metal content in the 3D printing material, the method uses the 3D printing material described above.

Preferably, the method comprises the following steps:

(1) mixing a formulated amount of the non-metallic material with a formulated amount of the second binder and then granulating to obtain pellets;

(2) mixing the pellets with a formulated amount of the first binder, to obtain a mixture; and

(3) extruding the mixture, to obtain the 3D printing material with a non-metal material content of not less than 16% in percent by volume. The volume percentages of the non-metal material used in the 3D printing material may be up to 82%. The volume percentages of the non-metal material used in the 3D printing material is 16 to 82%, for example, 16%, 20%, 25%, 30%, 35%, 40%, 45%, 50%, 55%, 60%, 65%, 70%, 75%, 80%, or the like.

The numerical range described in the embodiment of the present disclosure not only comprises the above-exemplified point values, but also includes any point value between the above-mentioned numerical ranges that are not exemplified, and due to the limited space and for the sake of brevity, this application is not exhaustive and does not list the specific point values included in the range.

Compared with the prior art, the embodiments of the present disclosure has the following beneficial effects:

(1) The solid content of the non-metal material in the 3D printing material provided by the embodiment of the present disclosure is significantly increased, the obtained 3D printed products have small high-temperature sintering shrinkage and less variation, and 10 to 30% increase on the product yield; meanwhile, problems such as raw material waste, complex and expensive equipment, and low accuracy caused by the solid form of the feed when the existing powder injection forming technology and photosensitive resins for the 3D printing technology are combined are avoided.

(2) The 3D printing material provided by the embodiment of the present disclosure can control the thickness of 3D printed layer by selecting different line diameters and controlling the heating temperature, and thus improve the accuracy of the product surfaces and product quality.

(3) The 3D printing material provided by the embodiment of the present disclosure can be heated and melted by heating using a simple thermocouple, without any need for an expensive laser heating equipment, and thus reduce energy consumption and production cost, and can be widely used for 3D printing.

(4) The preparation method of the 3D printing material provided by the embodiment of the present disclosure significantly increase the solid content of the non-metal material in the 3D printing material, so that the content of the non-metal material may be up to 82 wt %, and the method is simple and easy;

(5) The 3D printing method provided by the embodiment of the present disclosure combines the powder injection molding technology with the 3D printing technology, which can quickly print and produce complex products, shorten development process, and realize mass production and popularization.

After reading and understanding the accompanying drawings and detailed description, other aspects can be understood.

### BRIEF DESCRIPTION OF THE DRAWINGS

FIG. 1 is a process flow chart of 3D printing provided by one implementation of the present application.

### DETAILED DESCRIPTION OF EXEMPLARY EMBODIMENTS

In the following, the technical solution of the embodiments of the present disclosure is further explained in detail combining with the accompanying drawings and by means of specific implementations.

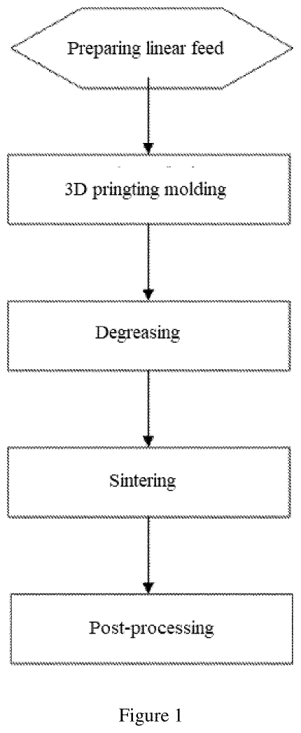

A 3D printing method, as shown in FIG. 1, comprises the following steps:

(1) preparing a linear 3D printing material, taking the 3D printing material as a raw material to print a raw blank with a preset shape through a 3D printer;

(2) degreasing the raw blank, and removing over 80 wt % of the first binder, to obtain a brown blank; and

(3) sintering the brown blank at a sintering temperature of 1200 to 1500° C. and a time of 2 to 3 h to obtain a sintered part, and post processing the sintered part to obtain a molded part.

The preparing a linear 3D printing material further comprises the following steps:

(1) mixing a non-metallic material with a size distribution D90 of 0.5 to 1.0 μm with a second binder and then performing spray drying granulation to obtain pellets with a size distribution D90 of 30 to 100 μm;

(2) mixing the pellets in Step (1) with a first binder, with a chamber temperature of 165 to 220° C. and a mixing time of 0.5 to 2 h during mixing, to obtain a mixture; and

(3) extruding the mixture, to obtain the 3D printing material.

### Embodiment 1

A high-solid content non-metal 3D printing material, is linear, and it comprises, in percent by volume, 44 vol % of a zirconia ceramic powder, 55.5 vol % of a first binder and 0.5 vol % of a second binder.

The preparation method of the high-solid content non-metal 3D printing material comprises the following steps:

(1) The zirconia ceramic powder with a size distribution D90 of 0.5 to 1.0 μm was mixed with the second binder (a phenolic resin solution) and then spray drying granulated at 120° C. to form semi-solidified powder agglomerate particles which has a size distribution D90 of 30 to 100 μm;

(2) The zirconia ceramic powder was mixed with the first binder, the first binder comprises: 85 wt % polyoxymethylene, 11 wt % backbone polymer, 1 wt % plasticizer, 0.5 wt % antioxidant, 0.5 wt % heat stabilizer, 1 wt % toughening agent, and 1 wt % lubricant polymer; the raw materials was added into an internal mixer, mixing-milling at 180° C. for 1 h;

(3) The mixed material obtained in Step (1) was extruded to a linear material with a diameter of 1.75 mm, then cooled to obtain the high-solid content non-metal 3D printing material which was wound to a coil shape to reserve.

The printing method using the high-solid content non-metal 3D printing material comprises the following steps:

(1) the linear feed was taken as a raw material to print a raw blank with a preset shape through a 3D printer;

(2) the raw blank obtained in Step (1) was degreased for 4 h at 110° C. and using nitric acid as the medium, to remove the first binder and obtain a brown blank;

(3) the brown blank obtained in Step (2) was placed in a high-temperature atmospheric furnace to sinter at 1450° C. for 3 h, and cooled to obtain a zirconia ceramic product.

The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 2

A high-solid content non-metal 3D printing material, is linear, and it comprises, in percent by volume, 40 vol % of a zirconia ceramic powder, 59.2 vol % of a first binder and 0.8 vol % of a second binder.

The preparation method of the high-solid content non-metal 3D printing material comprises the following steps:

(1) The zirconia ceramic powder with a size distribution D90 of 0.5 to 1.0 μm was mixed with the second binder (a phenolic resin solution) and then spray drying granulated at 120° C. to form semi-solidified powder agglomerates which are pellets having a size distribution D90 of 30 to 100 μm;

(2) The zirconia ceramic powder was mixed with the first binder, the first binder comprises: 85 wt % polyoxymethylene, 11 wt % backbone polymer, 1 wt % plasticizer, 0.5 wt % antioxidant, 0.5 wt % heat stabilizer, 1 wt % toughening agent, and 1 wt % lubricant polymer; the raw materials was added into an internal mixer, mixing-milling at 180° C. for 1 h;

(3) The mixed material obtained in Step (1) was extruded to a linear material with a diameter of 1.75 mm, then cooled to obtain the high-solid content non-metal feed for 3D printing, the linear feed was wound to a coil shape to reserve.

The printing method using the high-solid content non-metal 3D printing material comprises the following steps:

(1) the linear feed was taken as a raw material to print a raw blank with a preset shape through a 3D printer;

(2) the raw blank obtained in Step (1) was degreased for 4 h at 110° C. and using nitric acid as the medium, to remove the first binder and obtain a brown blank;

(3) the brown blank obtained in Step (2) was placed in a high-temperature atmospheric furnace to sinter at 1450° C. for 3 h, and cooled to obtain a zirconia ceramic product.

The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 3

A high-solid content non-metal 3D printing material, is linear, and it comprises, in percent by volume, 50 vol % of an alumina-zirconia ceramic powder, 49 vol % of a first binder and 1.0 vol % of a second binder.

The preparation method of the high-solid content non-metal 3D printing material comprises the following steps:

(1) The alumina-zirconia ceramic powder with a size distribution D90 of 0.5 to 1.0 μm was mixed with the second binder (a phenolic resin solution) and then spray drying granulated at 120° C. to form semi-solidified powder agglomerate particles which are pellets having a size distribution D90 of 30 to 100 μm;

(2) The alumina-zirconia ceramic powder was mixed with the first binder, the first binder comprises: 85 wt % polyoxymethylene, 11 wt % backbone polymer, 1 wt % plasticizer, 0.5 wt % antioxidant, 0.5 wt % heat stabilizer, 1 wt % toughening agent, and 1 wt % lubricant polymer; the raw materials was added into an internal mixer, mixing-milling at 180° C. for 1 h;

(3) The mixed material obtained in Step (1) was extruded to a linear material with a diameter of 1.75 mm, then cooled to obtain the high-solid content non-metal feed for 3D printing, the linear feed was wound to a coil shape to reserve.

The printing method using the high-solid content non-metal 3D printing material comprises the following steps:

(1) the linear feed was taken as a raw material to print a raw blank with a preset shape through a 3D printer;

(2) the raw blank obtained in Step (1) was degreased for 4 h at 110° C. and using nitric acid as the medium, to remove the first binder and obtain a brown blank;

(3) the brown blank obtained in Step (2) was placed in a high-temperature atmospheric furnace to sinter at 1500° C. for 3 h, and cooled to obtain an alumina-zirconia ceramic product.

The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 4

A high-solid content non-metal 3D printing material, is linear, and it comprises, in percent by volume, 16 vol % of a graphite material, 83.4 vol % of a first binder and 0.6 vol % of a second binder.

The preparation method of the high-solid content non-metal 3D printing material comprises the following steps:

(1) The graphite material with a size distribution D90 of 0.5 to 1.0 μm was mixed with the second binder (a phenolic resin solution) and then spray drying granulated at 120° C. to form semi-solidified powder agglomerate particles which are pellets having a size distribution D90 of 30 to 100 μm;

(2) The graphite material was mixed with the first binder, the first binder comprises: 85 wt % polyoxymethylene and paraffin, 11 wt % backbone polymer, 1 wt % plasticizer, 0.5 wt % antioxidant, 0.5 wt % heat stabilizer, 1 wt % toughening agent, and 1 wt % lubricant polymer; the raw materials was added into an internal mixer, mixing-milling at 165° C. for 2 h;

(3) The mixed material obtained in Step (1) was extruded to a linear material with a diameter of 0.1 mm, then cooled to obtain the high-solid content non-metal 3D printing material which was wound to a coil shape to reserve.

The printing method using the high-solid content non-metal 3D printing material comprises the following steps:

(1) the linear feed was taken as a raw material to print a raw blank with a preset shape through a 3D printer;

(2) the raw blank obtained in Step (1) was degreased for 24 h at 110° C. and using a petrochemical agent as the medium, to remove the first binder and obtain a brown blank;

(3) the brown blank obtained in Step (2) was placed in a high-temperature vacuum furnace to sinter at 1850° C. for 3 h, and cooled to obtain a graphite product.

The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 5

A high-solid content non-metal 3D printing material, is linear, and it comprises, in percent by volume, 82 vol % of a silicon nitride ceramic powder, 17.9 vol % of a first binder and 0.1 vol % of a second binder.

The preparation method of the high-solid content non-metal 3D printing material comprises the following steps:

(1) The silicon nitride ceramic powder with a size distribution D90 of 0.5 to 1 μm was mixed with the second binder (a phenolic resin solution) and then spray drying granulated at 120° C. to form semi-solidified powder agglomerate particles which are pellets having a size distribution D90 of 30 to 100 μm;

(2) The silicon nitride ceramic powder was mixed with the first binder, the first binder comprises: 85 wt % polyoxymethylene, 11 wt % backbone polymer, 1 wt % plasticizer, 0.5 wt % antioxidant, 0.5 wt % heat stabilizer, 1 wt % toughening agent, and 1 wt % lubricant polymer; the raw materials was added into an internal mixer, mixing-milling at 220° C. for 0.5 h;

(3) The mixed material obtained in Step (1) was extruded to a linear material with a diameter of 5 mm, then cooled to obtain the high-solid content non-metal 3D printing material which was wound to a coil shape to reserve.

The printing method using the high-solid content non-metal 3D printing material comprises the following steps:

(1) the linear feed was taken as a raw material to print a raw blank with a preset shape through a 3D printer;

(2) the raw blank obtained in Step (1) was degreased for 4 h at 110° C. and using nitric acid as the medium, to remove the first binder and obtain a brown blank;

(3) the brown blank obtained in Step (2) was placed in a high-temperature vacuum furnace to sinter at 1800° C. for 2.5 h, and cooled to obtain a silicon nitride ceramic product.

The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 6

A high-solid content non-metal 3D printing material has the same components and preparation method as those of Embodiment 3, except that the 50% alumina-zirconia ceramic powder was replaced with 55% silicon carbide ceramic powder and the volume percentage of the first binder was adaptively adjusted.

The 3D printing material obtained according to the above method was used, and the printing method of Embodiment 3 was utilized to mold an alumina toughened zirconia ceramic product. The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 7

A preparation method of the 3D printing material is the same as in Embodiment 3, except that the pellets obtained in Step (1) has a size distribution D90 of 5 to 20 μm.

The 3D printing material obtained according to the above method was used, and the printing method of Embodiment 3 was utilized to mold an alumina toughened zirconia ceramic product. The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

### Embodiment 8

A preparation method of the 3D printing material is the same as in Embodiment 3, except that the pellets obtained in Step (1) has a size distribution D90 of 120 to 180 μm.

The 3D printing material obtained according to the above method was used, and the printing method of Embodiment 3 was utilized to mold an alumina toughened zirconia ceramic product. The performance of the molded part is: due to the structure of the powder agglomerates is increased and the total surface area of the powder is reduced, the powder is easy to form agglomerates, and the thickness of the polymer film increases to cause a high fluidity of the feed (>MFI 1200), and it is wound in the shape of a coil with high toughness, suitable for automatic feeding processing.

Comparison 1

A preparation method of a 3D printing material is the same as in Embodiment 3, except that 50 vol % alumina-zirconia ceramic powder was directly mixed with 50 vol % first binder without preprocessing by the second binder.

The 3D printing material obtained according to the above method was used, and the printing method of Embodiment 3 was utilized to mold an alumina toughened zirconia ceramic product. The performance of the molded part is: due to the total surface area of the ultrafine powder is high, the powder is not easy to form agglomerates, and the thickness of the polymer film is thin, causing a poor fluidity of the feed (<MFI 200), and its toughness is poor and is easy to break, and cannot be wound into a coil shape.

The size shrinkage and product yield of the 3D printed products obtained in Embodiments 1-8 were tested, and the results were as follows: compared with the 3D printed products obtained in the prior art, the 3D printed products obtained in Embodiments 1-8 had small high-temperature sintering shrinkage and less variation, and 10 to 30% increase on the product yield.

The second binder in Embodiments 1-8 were replaced with other thermosetting polymer materials, for example thermosetting polymer materials selected from any one or a combination of two of phenolic resin, urea-formaldehyde resin, melamine resin, unsaturated polyester resin, epoxy resin, organic silicone resin, and polyurethane; or replaced with other thermoplastic polymer materials, for example thermoplastic polymer materials selected from any one or a combination of two of polypropylene, polyvinyl chloride, polystyrene, polyoxymethylene, polycarbonate, polyamide, acrylic plastic, polysulfone, and polyphenylene oxide. Compared with the 3D printed products obtained in the prior art, the obtained 3D printed products had small high-temperature sintering shrinkage and less variation, and 10 to 30% increase on the product yield.

The applicant declares that the above are only specific implementations of this application, but the scope of protection of this application is not limited thereto, and those skilled in the art should understand that changes or substitutions that disclosed in this application and that can easily come up to any person skilled in the art fall within the scope of protection and disclosure of this application.

1. A 3D printing material, comprising:
a non-metallic material 16 to 82 vol %;
a first binder 17.9 to 83 vol %; and
a second binder 0.1 to 1 vol %,
wherein the 3D printing material is linear.

2. The 3D printing material according to claim 1, wherein, the linear 3D printing material has a diameter in the range of 0.1 to 5 mm.

3. The 3D printing material according to claim 1, wherein, the non-metal material has a size distribution D90 of 0.5 to 1.0 μm.

4. The 3D printing material according to claim 1, wherein, the non-metal material is selected from any one or a combination of at least two of oxide ceramic materials, carbide ceramic materials, nitride ceramic materials, and graphite materials.

5. A preparation method for the 3D printing material according to claim 1, wherein, the preparation method comprises the following steps:
(1) mixing a formulated amount of the non-metallic material with a formulated amount of the second binder and then granulating to obtain pellets;
(2) mixing the pellets with a formulated amount of the first binder, to obtain a mixture; and
(3) extruding the mixture, to obtain the 3D printing material.

6. The preparation method according to claim 5, wherein, the non-metal material in Step (1) has a size distribution D90 of 0.5 to 1.0 μm.

7. The preparation method according to claim 5 or 6, wherein, the preparation method for the 3D printing material comprises the following steps:
(1) mixing the formulated amount of the non-metallic material with a size distribution D90 of 0.5 to 1.0 μm with the formulated amount of the second binder and then performing spray drying granulation to obtain pellets with a size distribution D90 of 30 to 100 μm;
(2) mixing-milling the pellets with the formulated amount of the first binder, with a chamber temperature of 165 to 220° C. and a mixing-milling time of 0.5 to 2 h during mixing-milling, to obtain the mixture;
(3) extruding the mixture, to obtain the 3D printing material.

8. A 3D printing method, wherein, the 3D printing method uses the 3D printing material according to claim 1.

9. The 3D printing method according to claim 8, wherein, the 3D printing method comprises the following steps:
(1) taking the 3D printing material as a raw material to print a raw blank with a preset shape through a 3D printer;
(2) degreasing the raw blank to obtain a brown blank; and
(3) sintering the brown blank to obtain a molded part.

10. The use 3D printing method according to claim 9, wherein, the degreasing in Step (2) removes over 80 wt % of the total amount of the first binder and the second binder.

11. The 3D printing method according to claim 9 or 10, wherein, the 3D printing method comprises the following steps:
(1) taking the 3D printing material as the raw material to print the raw blank with the preset shape through the 3D printer;
(2) degreasing the raw blank, and removing over 80 wt % of the total amount of the first binder and the second binder, to obtain the brown blank; and
(3) sintering the brown blank at a sintering temperature of 1200 to 1500° C. and a time of 2 to 3 h to obtain a sintered part, and post processing the sintered part to obtain a molded part.

12. A method of increasing non-metal content in a 3D printing material, wherein, the method uses the 3D printing material according to claim 1.

13. The 3D printing material according to claim 1, wherein the first binder is selected from plastic-based binders and/or wax-based binders.

14. The 3D printing material according to claim 1, wherein the second binder is selected from thermosetting polymer materials and/or thermoplastic polymer materials.

15. The 3D printing material according to claim 1, wherein the thermosetting polymer materials are selected from any one or a combination of at least two of phenolic resin, urea-formaldehyde resin, melamine resin, unsaturated polyester resin, epoxy resin, organic silicone resin, and polyurethane, and
the thermoplastic polymer materials are selected from any one or a combination of at least two of polypropylene, polyvinyl chloride, polystyrene, polyoxymethylene, polycarbonate, polyamide, acrylic plastic, polysulfone, and polyphenylene oxide.

16. The preparation method according to claim 5, wherein the pellets in Step (1) have a size distribution D90 of 30 to 100 μm.

17. The preparation method according to claim 5, wherein:
the granulating in Step (1) is spray drying granulation,
the mixing in Step (2) comprises mixing-milling,
a chamber temperature during the mixing-milling is 165 to 220° C., and
a mixing-milling time is 0.5 to 2 h, and preferably is 1 h.

18. The 3D printing method according to claim 9, wherein:
the degreasing in Step (2) is selected from any one or a combination of at least two of thermal degreasing, water degreasing, catalytic degreasing, and solvent degreasing, and
a catalyst of the catalytic degreasing is nitric acid and/or oxalic acid.

19. The 3D printing method according to claim 9, wherein:
a sintering temperature in Step (3) is 1200 to 1500° C., and
a sintering time in Step (3) is 2 to 3 h.

20. The 3D printing method according to claim 9, wherein post-processing is performed after sintering in Step (3).
